(19) United States
(12) Patent Application Publication
(10) Pub. No.: US 2026/0125983 A1
(43) Pub. Date: May 7, 2026

(54) SHAFT ASSEMBLY FOR A GAS TURBINE ENGINE

(71) Applicant: Pratt & Whitney Canada Corp., Longueuil (CA)

(72) Inventors: Rose-Elizabeth Banville, Longueuil (CA); Hugo Quintin, Varennes (CA); Jeffica Hannesto, La Prairie (CA); Michel Labbe, Montreal (CA)

(21) Appl. No.: 18/934,863

(22) Filed: Nov. 1, 2024

(51) Int. Cl. F01D 5/02

(52) U.S. Cl. CPC F01D 5/026; F05D 2230/60; F05D 2240/61; F05D 2240/70; F05D 2260/31

(57) ABSTRACT

A shaft assembly for a gas turbine engine including an outer shaft, an inner shaft, a lock nut, a locking shaft, and a washer. The outer shaft includes a bore extending between first and second ends. A portion of the inner shaft extends within the bore of the outer shaft. The lock nut is secured to the inner shaft proximate a second axial end of the inner shaft. The locking shaft includes a body portion extending between a coupling end and a retaining end. The locking shaft is disposed within the bore, with the coupling end engageable with an end of the lock nut. A washer is engageable with the retaining end and the outer shaft second end. In the assembled state, the locking shaft prevents rotation of the lock nut.

### TECHNICAL FIELD

This disclosure relates generally to gas turbine engines and particularly to a shaft assembly for such gas turbine engines.

### BACKGROUND INFORMATION

Various shaft assemblies for gas turbine engines are known in the art, and mechanical locking systems are known in the art for securing shaft components using a locking mechanism, such as through interference engagement with associated bearings of a shaft component. While these known mechanical locking systems have various advantages, there is still room in the art for improvement. In particular, there is a need in the art for a mechanical locking system which can be conveniently and efficiently added to or removed from a gas turbine engine shaft assembly.

### SUMMARY

According to an aspect of the present disclosure, a shaft assembly for a gas turbine engine is provided. The shaft assembly includes an outer shaft, an inner shaft, a lock nut, a locking shaft, and a washer. The outer shaft includes a first end, a second end, an axial centerline, and a bore extending between the first end and the second end. The inner shaft includes a first axial end and a second axial end. At least a portion of the inner shaft extends within the outer shaft bore. The inner shaft extends along the axial centerline. The lock nut includes a base extending between a first nut end and a second nut end. The lock nut is secured to the inner shaft proximate the second axial end. The washer includes a washer inner circumferential surface and a washer outer circumferential surface. The washer inner circumferential surface is engageable with the locking shaft retaining end and the washer outer circumferential surface is engageable with the outer shaft at the second end. In an assembled state, the locking shaft prevents rotation of the lock nut.

In any of the aspects or embodiments described above and herein, the second end includes an outer assembly surface and a slot, the slot extending from the outer assembly surface to the bore. The washer outer circumferential surface may include a radially-outward protruding tab. In the assembled state, the radially-outward protruding tab engages the slot.

In any of the aspects or embodiments described above and herein, the retaining end includes a second opening, an inner circumferential surface, an outer circumferential surface, and a gap. The gap extends between the inner circumferential surface and the outer circumferential surface. The washer inner circumferential surface includes a radially-inward protruding tab. In the assembled state, the radially-inward protruding tab engages the gap.

In any of the aspects or embodiments described above and herein, the lock nut includes a castellation extending from the first nut end or the second nut end. The castellation protrudes within the outer bore shaft. The coupling end includes an outer shaft surface and a lug. The lug may extend radially from the outer shaft surface to an outer radial surface. The lug may extend axially from the coupling end to a distal end. In the assembled state the coupling end lug is retained within the lock nut castellation.

In any of the aspects or embodiments described above and herein, the coupling end includes an opening forming a central chamber extending axially towards the retaining end. In the assembled state, the inner shaft second axial end is disposed within the central chamber.

In any of the aspects or embodiments described above and herein, the lock nut includes a plurality of castellations circumferentially disposed around the lock nut and extending from the first nut end or the second nut end. The plurality of castellations may extend within the outer shaft bore. The coupling end may include an outer shaft surface and a plurality of lugs circumferentially disposed around the coupling end. Each of the plurality of lugs may extend radially from the outer shaft surface to an outer radial surface. Each of the plurality of lugs may extend axially from the coupling end to a distal end. Each of the plurality of lugs may be angularly offset from another by a predetermined angle. In the assembled state, a first of the plurality of lugs may engage a first of the plurality of castellations. A second of the plurality of lugs may engage a second of the plurality of castellations.

In any of the aspects or embodiments described above and herein, the shaft assembly includes a retaining ring disposed within the outer shaft bore aft of the washer. The retaining ring may include a ring outer circumferential surface which engages a groove disposed in an inner bore surface of the outer shaft.

In any of the aspects or embodiments described above and herein, the inner shaft may comprise a low pressure turbine shaft.

In any of the aspects or embodiments described above and herein, the locking shaft retaining end includes an outer circumferential surface extending axially forward to a tapered region, the tapered region extending axially towards the locking shaft body such that the outer circumferential surface tapers radially inward toward an outer shaft surface of the locking shaft body.

In any of the aspects or embodiments described above and herein, the retaining end outer circumferential surface includes at least one radial seal. At least one radial seal may engage an inner bore surface of the outer shaft in the assembled state.

In any of the aspects or embodiments described above and herein, the inner shaft is in driving communication with a rotatable load.

According to an aspect of the present disclosure, a locking shaft for a gas turbine engine having a rotating assembly is provided. The locking shaft includes a coupling end, a retaining end, and a body extending axially between the coupling end and the retaining end. The body extends between the coupling end and the retaining end. The body includes a central chamber, an inner shaft surface, and an outer shaft surface. The coupling end includes a lug extending radially from the outer shaft surface to an outer radial surface. The lug may extend axially from the coupling end to a distal end. The retaining end includes a cavity, an inner circumferential surface, an outer circumferential surface, and a gap. The gap may extend between the inner circumferential surface and the outer circumferential surface.

In any of the aspects or embodiments described above and herein, the coupling end includes a plurality of lugs circumferentially disposed around the coupling end. Each of the plurality of lugs may be angularly offset from another by a predetermined angle.

In any of the aspects or embodiments described above and herein, the retaining end includes a plurality of gaps circumferentially disposed around the retaining end.

In any of the aspects or embodiments described above and herein, the locking shaft retaining end outer circumferential surface extends axially forward to a tapered region, and the tapered region extends axially towards the body such that the outer circumferential surface tapers radially inward toward the outer shaft surface of the body.

In any of the aspects or embodiments described above and herein, the coupling end includes a opening in communication with the central chamber. The central chamber may extend axially from the opening towards the retaining end.

In any of the aspects or embodiments described above and herein, the coupling end includes a first diameter and the retaining end includes a second diameter. The first diameter may be less than the second diameter.

According to an aspect of the present disclosure, a method of assembly a gas turbine engine component is provided. The method includes the steps of providing a shaft assembly. The shaft assembly includes an outer shaft, an inner shaft, and a lock nut. The outer shaft extends axially along a centerline from a forward end to an aft end. The inner shaft extends along the centerline. A portion of the inner shaft is disposed within a bore of the outer shaft. The method further includes the steps of securing a lock nut to a threaded section of the inner shaft, inserting a locking shaft within the bore, orienting a washer, and inserting the washer within the shaft assembly. Inserting the locking shaft within the bore includes engaging a first end of the locking shaft with an end of the lock nut. Orienting the washer includes aligning a radially-inward protruding tab with a second end of the locking shaft and aligning a radially-outward protruding tab with the outer shaft aft end. Inserting the washer within the shaft assembly engages the radially-inward protruding tab with the second end of the locking shaft and the radially-outward protruding tab with the aft end of the outer shaft.

The present disclosure may include any one or more of the individual features disclosed above and/or below alone or in any combination thereof.

The foregoing features and the operation of the invention will become more apparent in light of the following description and the accompanying drawings.

### BRIEF DESCRIPTION OF THE DRAWINGS

FIG. 1 is a diagrammatic illustration of an aircraft powered by a pair of aircraft propulsion systems according to an embodiment of the present disclosure.

FIG. 2 is a diagrammatic cross-sectional view of a gas turbine engine.

FIG. 3 is a diagrammatic cross-sectional view of a portion of the gas turbine engine of FIG. 1, illustrating a shaft assembly according to an embodiment of the present disclosure.

FIG. 4 is an exploded view of the shaft assembly of FIG. 3.

FIG. 5 is a rear schematic view of the shaft assembly of FIG. 3, along lines A-A.

FIG. 6 is an isometric view of a lock nut according to an embodiment of the present disclosure.

FIG. 7 is an isometric view of a locking shaft according to an embodiment of the present disclosure.

FIG. 8 is a front schematic view of a washer according to an embodiment of the present disclosure.

FIG. 9 is a diagrammatic cross-sectional view of a portion of the gas turbine engine of FIG. 1, illustrating a shaft assembly according to an embodiment of the present disclosure

### DETAILED DESCRIPTION

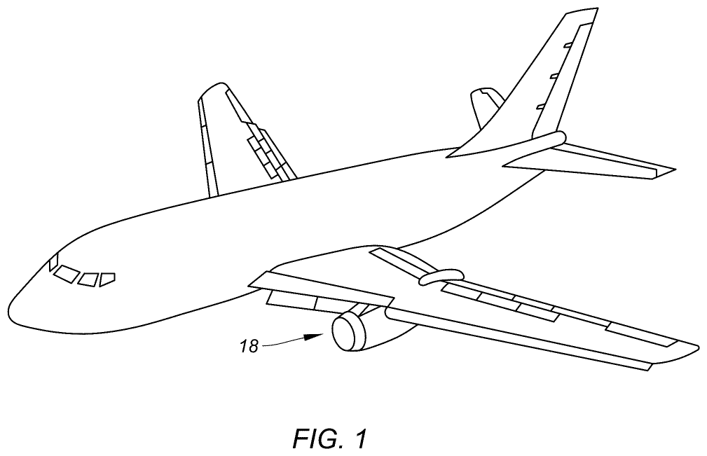

FIG. 1 diagrammatically illustrates an aircraft including a pair of present disclosure aircraft propulsion systems 18. The present disclosure may be utilized in aircraft applications other than the two engine aircraft shown in FIG. 1.

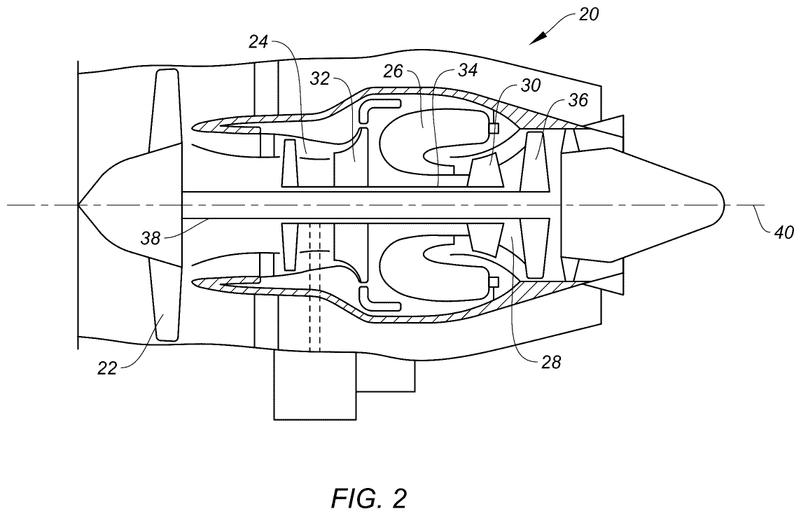

FIG. 2 illustrates an aircraft engine depicted as a gas turbine engine 20 of a type preferably provided for use in subsonic flight, generally comprising in serial flow communication a fan 22 through which ambient air is propelled, a compressor section 24 for pressurizing the air, a combustor 26 in which the compressed air is mixed with fuel and ignited for generating an annular stream of hot combustion gases, and a turbine section 28 for extracting energy from the combustion gases. High pressure rotor(s) 30 of the turbine section 28 are drivingly engaged to high pressure rotor(s) 32 of the compressor section 24 through a high pressure shaft 34. Low pressure rotor(s) 36 of the turbine section 28 are drivingly engaged to the fan rotor 22 and to other low pressure rotor(s) (not shown) of the compressor section 24 through a low pressure (LP) shaft 38 extending within the high pressure shaft 34 and rotating independently therefrom.

The terms “forward”, “leading”, “aft”, and “trailing” are used herein to indicate the relative position of a component or surface. As core air flow passes through the engine, a “leading edge” of a stator vane or rotor blade encounters core gas air before the “trailing edge” of the same. In a conventional axial engine such as that shown in FIG. 2, the fan section is “forward” of the compressor section and the turbine section is “aft” of the compressor section. The terms “inner radial” and “outer radial” refer to relative radial positions from the engine centerline 40. An inner radial component or path is disposed radially closer to the engine centerline 40 than an outer radial component or path. The gas turbine engine 20 diagrammatically shown is an example provided to facilitate the description herein. The present disclosure is not limited to any particular gas turbine engine configuration, including the two-spool engine configuration shown, and may be utilized with single spool gas turbine engines as well as three spool gas turbine engines and the like.

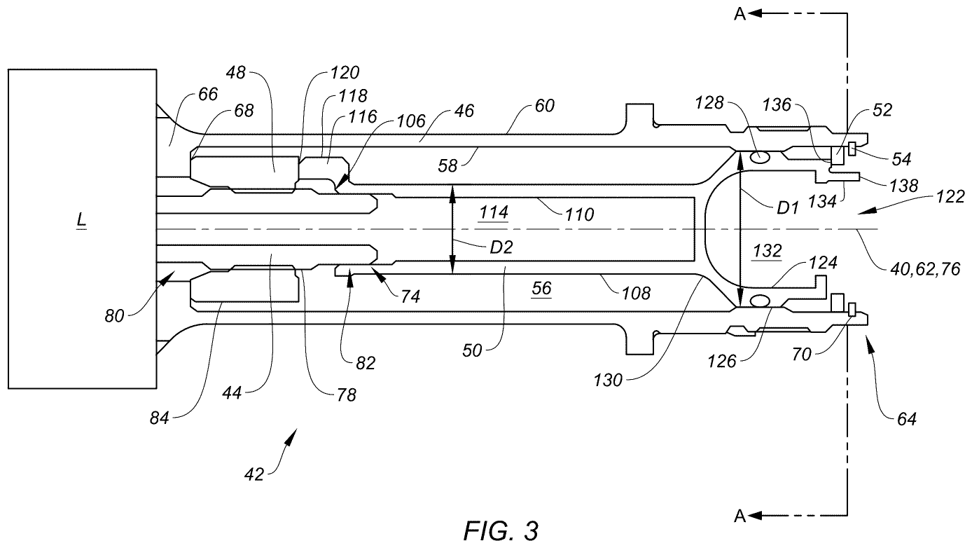

FIG. 3 is a diagrammatic cross-sectional view of a portion of the gas turbine engine of FIG. 1, illustrating a shaft assembly 42. The shaft assembly 42 includes an inner shaft 44, an outer shaft 46, a lock nut 48, a locking shaft 50, a washer 52, and a retaining ring 54. The shaft assembly 42 may be one used in various rotating assemblies within the gas turbine engine, for instance within the turbine section or other rotating components of the gas turbine engine such as gear shafts, torque shafts, and propeller shafts. Other locations for the shaft assembly 42 are not meant to be precluded.

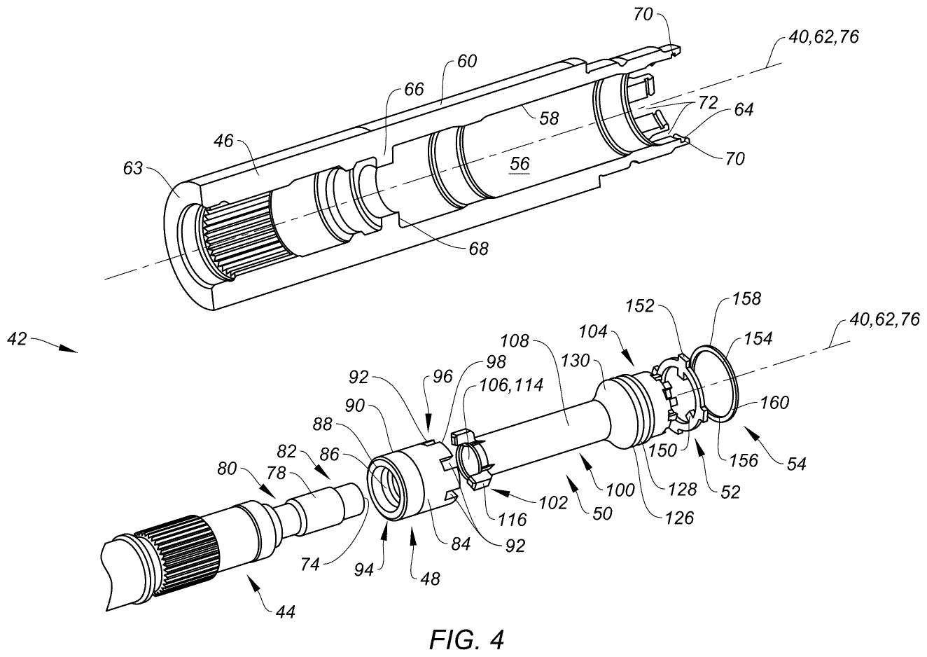

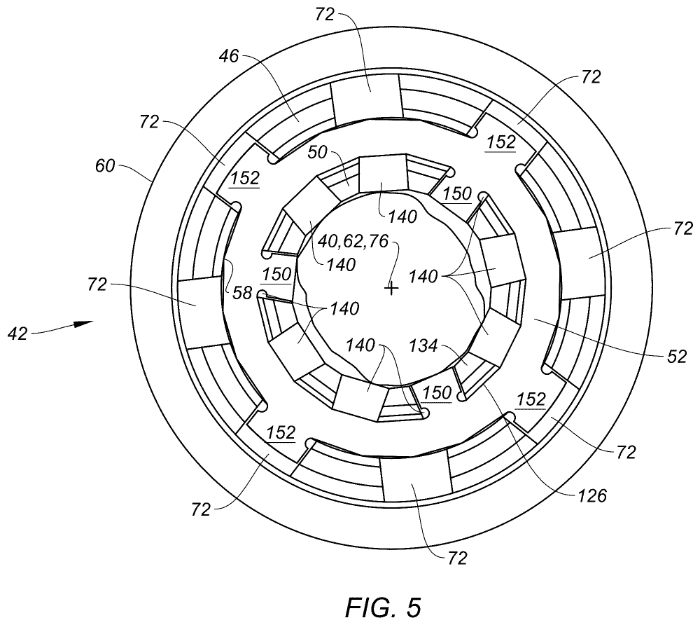

Referring to FIGS. 3-5, the outer shaft 46 includes a bore 56, an inner bore surface 58, and an outer assembly surface 60. The outer shaft 46 extends axially along a central axis 62 between a forward end 63 and an aft end 64, and extends radially between the bore 56 and the outer assembly surface 60. In the depicted embodiment, the inner bore surface 58 includes a raised annular shoulder 66 extending from a nut contact surface 68 toward the forward end 63. A groove 70 may be disposed on the inner bore surface 58 proximate the aft end 64. A plurality of axial slots 72 are circumferentially spaced apart around the outer assembly surface 60 and extend between the outer assembly surface 60 and the inner bore surface 58 (e.g., towards bore 56). The plurality of slots 72 extend from the aft end 64 towards the forward end 63. Other arrangements for the slots 72 along the outer assembly surface 60 are not meant to be precluded. The number, size, and arrangement of the axial slots 72 may vary, for instance based on the geometry of the washer 52 (discussed in more detail below). The exemplary outer shaft 46 of the present disclosure includes eight axial slots 72 (see FIG. 5).

The inner shaft 44 includes a first axial end (not shown) and a second axial end 74 along an axial centerline 76. The inner shaft 44 is rotatable about the axial centerline 76, which may coincide with the engine centerline 40 and/or central axis 62. The inner shaft 44 includes a threaded shaft segment 78 proximate the second axial end 74 and extending axial from a forward shaft segment 80 to an aft shaft segment 82. The inner shaft 44 may be in driving communication with a rotatable load L, such as a rotor assembly, fan blades, and the like. In some embodiments, the inner shaft 44 may comprise the LP shaft 38. Other shafts of the engine are not meant to be precluded.

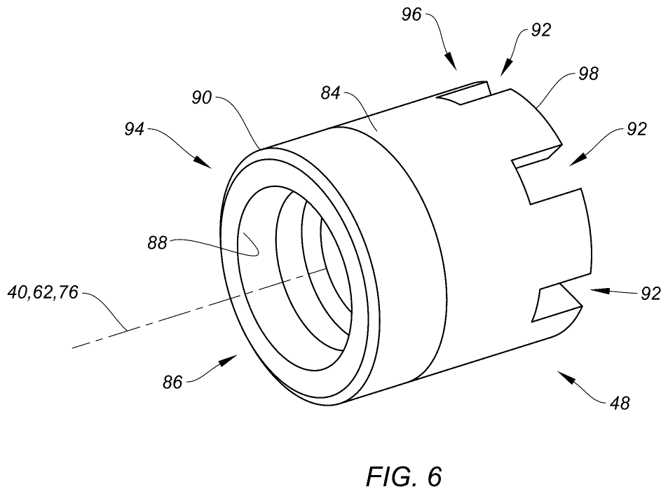

Referring to FIGS. 3-6, the lock nut 48 threadedly engages the threaded shaft segment 78 to axially retain the rotatable load L. The lock nut 48 may include a lock nut base 84, a threaded nut bore 86, an inner circumferential surface 88, and outer circumferential surface 90, and a plurality of castellations 92. The lock nut base 84 extends axially along the central axis 62 between a first nut end 94 and a second nut end 96, and extends radially between the threaded nut bore 86 and the outer circumferential surface 90. The castellations 92 are circumferentially disposed around the second nut end 96 and extend axially from the second nut end 96 to a distal castellation end 98. The number, size, and arrangement of the castellations 92 may vary and other configurations of the castellations are not meant to be precluded. The castellations 92 may be disposed circumferentially around the second nut end 96 a predetermined angular distance from the other (e.g., between 30-72 degrees).

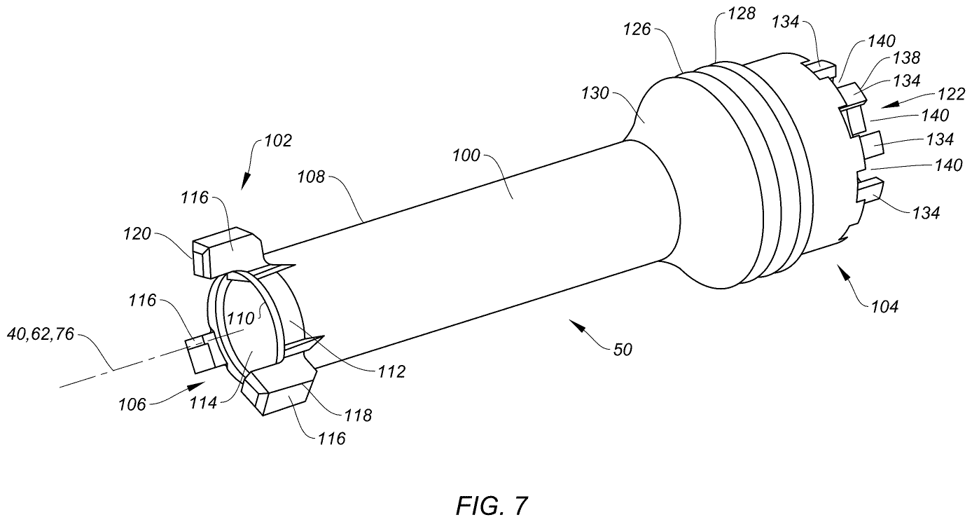

Referring to FIGS. 3-5 and 7, the locking shaft 50 includes a locking shaft body 100 extending axially between a coupling end 102 and a retaining end 104, and extending radially between a first opening 106 and a locking shaft outer shaft surface 108. The lock shaft body 100 includes an inner shaft surface 110, and the outer shaft surface 108. The locking shaft 50 extends axially along the central axis 62 between the coupling end 102 and the retaining end 104. A raised annular shoulder 112 may circumscribe the coupling end 102 and the first opening 106. The locking shaft 50 may include a central chamber 114 extending from the first opening 106 in the coupling end 102 axially towards the retaining end 104. The coupling end 102 may include one or more lugs 116 circumferentially disposed around the coupling end 102. Each of the lugs 116 may extend radially from the outer shaft surface 108 to an outer radial surface 118, and extend axially from the coupling end 102 to a coupling element distal end 120. The number of lugs 116 will depend on the specific application and location of shaft assembly 42 and may any number of lugs 116. One embodiment includes three (3) lugs 116 angularly offset from one another by a predetermined angle (e.g., approximately 120 degrees), though other angles are not meant to be precluded. In some embodiments, the number of lugs 116 may depend on the number of castellations 92 of the lock nut 48. For example, the number of castellations 92 may (or may not) exceed the number of lugs 116, such that the ratio of castellations 92 to lugs 116 may be 1:1, 2:1, 3:1, etc. to facilitate assembly as described below.

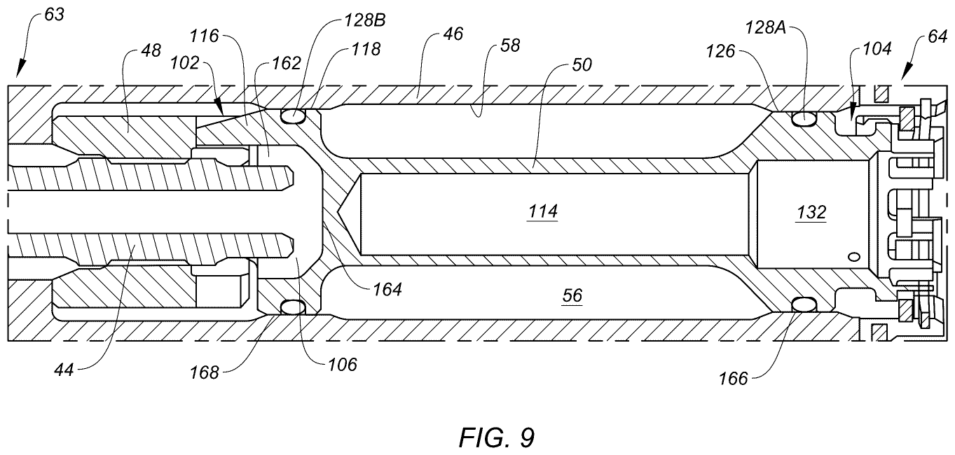

The retaining end 104 includes a second opening 122, an inner circumferential surface 124, and an outer circumferential surface 126. The retaining end 104 extends axially along the central axis 62 from the locking shaft body 100 towards the retaining end second opening 122, and extends radially between the second opening 122 and the retaining end outer circumferential surface 126. A radial seal 128 (e.g., an O-ring) may be disposed on the retaining end outer circumferential surface 126. In some embodiments, locking shaft 50 may include a second radial seal 128B (generally referred to as “128”) disposed on the outer radial surface 118 of the coupling end 102 (see e.g., FIG. 9; discussed below). The number, size, and arrangement of the radial seals 128 may vary and other configurations of the seals are not meant to be precluded. A distance D1 from the second opening 122 to the retaining end outer circumferential surface 126 (e.g., a first diameter) may be greater than a distance D2 from the first opening 106 to the outer shaft surface 108 (e.g., a second diameter). The retaining end 104 may include a tapered region 130. The tapered region 130 extends axially towards the locking shaft body 100 such that outer circumferential surface 126 tapers radially inward toward the outer shaft surface 108 of the locking shaft body 100. The retaining end 104 may include a cavity 132 extending from the second opening 122 toward the locking shaft body 100. The retaining end 104 may include a plurality of circumferentially disposed retaining elements 134 and a key-washer contact surface 136. Each of the retaining elements 134 extends axially from the key-washer contact surface 136 to a distal retaining element end 138. The adjacent retaining elements 134 are circumferentially separated by a gap 140. The number, size, and arrangement of the retaining elements 134 and/or gaps 140 may vary and other configurations of the retaining elements 134 and/or gaps 140 are not meant to be precluded.

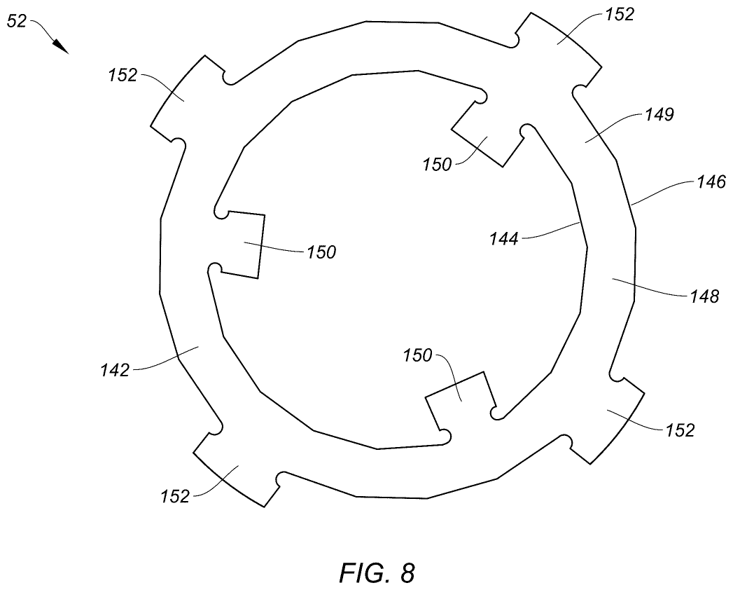

Referring to FIGS. 3-5 and 8, washer 52 includes an annular body 142 with an inner circumferential surface 144, an outer circumferential surface 146, and opposing axial surfaces 148. The inner circumferential surface 144 and the outer circumferential surface 146 are radially spaced apart to define a radial thickness 149 of the annular body. The inner circumferential surface 144 includes radially-inward protruding lugs or tabs 150 arranged about its circumference, while the outer circumferential surface 146 includes radially-outward protruding lugs or tabs 152 arranged about its circumference. The number, sizing, shape and arrangement of the radially-inward protruding tabs 150 and radially-outward protruding tabs 152 may vary to optimize alignment accuracy when installing the washer 52 in the shaft assembly 42. As described herein, the washer 52 of the present disclosure may be referred to as a classified key-washer having a plurality of angular arrangements (e.g., different angular arrangements) of radially-inward protruding tabs 150 and radially-outward protruding tabs 152 to engage with the retaining end gaps 140 and/or outer shaft slots 72.

Referring to FIGS. 3-5, the retaining ring 54 may comprise a housing ring, snap ring, spiral ring, and the like. The retaining ring includes an annular body 154 with an inner circumferential surface 156, an outer circumferential surface 158, and opposing axial surfaces 160. The inner circumferential surface 156 and the outer circumferential surface 158 are radially spaced apart to define a radial thickness of the annular body 154.

During assembly of the shaft assembly 42, the inner shaft 44 is disposed within the outer shaft 46 such that threaded shaft segment 78, aft shaft segment 82, and second axial end 74 protrude within the bore 56 of the outer shaft 46. Inner shaft 44 is configured to engage outer shaft 46 in a splined connection such that rotation of the inner shaft 44 and outer shaft 46 may be synchronous (e.g., inner shaft 44 and outer shaft 46 do not rotate independently of each other). Lock nut 48 is secured to the threaded shaft segment 78 and may contact the nut contact surface 68 of outer shaft 46. The lock nut 48 is secured to a particular torque rating for any given application such that the castellations 92 will extend towards the inner shaft second axial end 74 and outer shaft aft end 64. Locking shaft 50 is placed within the bore 56 of the outer shaft 46 such that a portion of the inner shaft 44 (e.g., second axial end 74 and/or aft shaft segment 82) may be maintained within (e.g., fit within) the chamber 114 proximate the first opening 106 (e.g., a clearance or transition fit). Similarly, lugs 116 may be maintained within (e.g., fit within and engage) the lock nut castellation(s) 92. Engagement between lugs 116 and castellations 92 may be a clearance or transition fit to retain (e.g., loosely retain) the lugs 116 within castellations 92. Other forms of engagement are not meant to be precluded. In the exemplary shaft assembly 42, lugs 116 are configured as a male element for engagement within female castellation 92, however, combinations of male and female configurations are acceptable for lugs 116 and lock nut castellations 92 in alternate embodiments of the present disclosure.

Upon engagement of lugs 116 with castellations 92, coupling end 102 of the locking shaft 50 is loosely retained within the shaft assembly 42. The locking shaft body 100 is disposed radially inward of the outer shaft 46 and extends axially along the axial centerline 76. A portion of the retaining end outer circumferential surface 126 may fit within and engage the inner bore surface 58 of outer shaft 46. For example, seal 128 may deform against the inner bore surface 58, forming a fluid tight seal.

The retaining end second opening 122 may be disposed proximate the outer shaft aft end 64 and may be axially coincident to the plurality of slots 72. The washer 52 may be angularly oriented with respect to the shaft assembly 42 such that the radially-inward protruding tabs 150 are aligned with gaps 140 of the locking shaft 50 and the radially-outward protruding tabs 152 are aligned with slots 72 of the outer shaft 46. Once oriented, the washer 52 is inserted between the outer shaft inner bore surface 58 and the retaining end outer circumferential surface 126 to secure the locking shaft retaining end 104 within the shaft assembly 42, ensuring axial alignment of the locking shaft 50 with the engine centerline 40. Radially-inward protruding tabs 150 of the washer 52 may fit within and engage (e.g., via transition, clearance, or interference engagement) one or more gaps 140 formed between adjacent retaining elements 134, and radially-outward protruding tabs 152 of the washer 52 may fit within and engage (e.g., via transition, clearance, or interference engagement) one or more slots 72 of the outer shaft 46. Then, retaining ring 54 may be secured within the groove 70 of the outer shaft 46 to axially retain the washer 52. Once in the assembled state, the washer 52 may be retained (e.g., loosely retained) in an axial and radial direction and may expand under centrifugal loads. The lugs 116 of the locking shaft 50 may contact (e.g., abut) the castellation 92 of the lock nut 48 under rotation, preventing the lock nut 48 from rotating relative to the inner shaft 44 (e.g., preventing loosening of the nut). Thus, in the assembled state the locking shaft 50 secures the inner shaft 44 in a desired axial and radial configuration.

In some embodiments of the present disclosure, the radially-inward protruding tabs 150 and the radially-outward protruding tabs 152 may not align with the gaps 140 and slots 72 such that the washer 52 may be retained within the shaft assembly 42. In such cases, the process of assembly may include selecting one or more washers 52 having a particular classification (e.g., an angular arrangement of radially-inward protruding tabs 150 and/or radially-outward protruding tabs 152) so that, when oriented, the radially-inward protruding tabs 150 are aligned with gaps 140 of the locking shaft 50 and the radially-outward protruding tabs 152 are aligned with slots 72 of the outer shaft 46.

FIG. 9 illustrates an alternate embodiment of the shaft assembly 42 of the present disclosure. The locking shaft 50 includes a first radial seal 128A and a second radial seal 128B (collectively referred to as “128”). The first radial seal 128A may be disposed on the retaining end outer circumferential surface 126, and the second radial seal 128B may be disposed on the coupling end outer radial surface 118. First opening 106 extends from the coupling end 102 towards a rearward surface 164. As depicted, central chamber 114 is in communication with the retaining end cavity 132. In the assembled state, a portion of the retaining end outer circumferential surface 126 may fit within and engage the outer shaft 46 at a first interface 166 (e.g., proximate aft end 64) and a portion of the coupling end outer radial surface 118 may fit within and engage the outer shaft at a second interface 168 (e.g., proximate forward end 63). During engagement, seals 128 may deform against the inner bore surface 58 at the first interface 166 and the second interface 168. First interface 166 may form a fluid tight seal within the bore 56, and second interface 168 may form a fluid tight seal between inner shaft 44, lock nut 48, and coupling end 102. Upon engagement of the locking shaft 50 within the bore 56, a circumferential spacing 162 may be disposed between the inner shaft 44 and the locking shaft first opening 106. In the assembled state, radial seals 128 provide additional support and damping of the locking shaft 50 within the shaft assembly 42.

The shaft assembly 42 of the present disclosure may eliminate the need to remove the locking shaft 50, adjust a torque on the lock nut 48, and/or reposition the locking shaft 50 to secure the locking shaft 50 within the shaft assembly 42. During assembly, the angular position of the washer 52 may be optimized so that when the radially-outward protruding tabs 152 are aligned with the outer shaft slots 72, the radially-inward protruding tabs 150 are aligned with the retaining end gaps 140. Similarly, though less preferably, the angular position of the locking shaft 50 may be optimized to ensure proper alignment of the radially-outward protruding tabs 152 with the outer shaft slots 72 and the radially-inward protruding tabs 150 with the retaining element gaps 140. For example, the angular position of the locking shaft 50 within the outer shaft 46 may be changed to align the lugs 116 with different castellations 92 (e.g., the locking shaft 50 may be rotated such that the lugs 116 are received within different castellations 92 of the lock nut 48). Thus, the angular position of the retaining elements gaps 140 relative to the outer shaft slots 72 may be optimized to ensure alignment of the washer 52 within the shaft assembly 42. The locking shaft 50 of the present disclosure may therefore be installed within the shaft assembly 42 without requiring adjustment of the lock nut 48 which would require the disassembly and reassembly of the locking shaft 50 within the shaft assembly 42.

While various embodiments of the present disclosure have been described, it will be apparent to those of ordinary skill in the art that many more embodiments and implementations are possible within the scope of the disclosure. For example, the present disclosure as described herein includes several aspects and embodiments that include particular features. Although these features may be described individually, it is within the scope of the present disclosure that some or all of these features may be combined with any one of the aspects and remain within the scope of the disclosure. Accordingly, the present disclosure is not to be restricted except in light of the attached claims and their equivalents.

What is claimed is:

1. A shaft assembly for a gas turbine engine, comprising:
an outer shaft having a first end, a second end, an axial centerline and a bore extending between the first end and the second end;
an inner shaft having a first axial end and a second axial end, at least a portion of the inner shaft extending within the outer shaft bore, the inner shaft extending along the axial centerline;
a lock nut having a base extending between a first nut end and a second nut end, the lock nut secured to the inner shaft proximate the second axial end;
a locking shaft including a coupling end, a retaining end, and a body portion extending between the coupling end and the retaining end, the locking shaft disposed within the outer shaft bore and extending along the axial centerline, and the coupling end engageable with the lock nut first nut end or the second nut end; and
a washer including a washer inner circumferential surface and a washer outer circumferential surface, the washer inner circumferential surface engageable with the locking shaft retaining end and the washer outer circumferential surface engageable with the outer shaft at the second end;
wherein in an assembled state the locking shaft prevents rotation of the lock nut.

2. The shaft assembly of claim 1, wherein
the second end includes an outer assembly surface and a slot, the slot extending from the outer assembly surface to the bore;
the washer outer circumferential surface includes a radially-outward protruding tab; and
in the assembled state the radially-outward protruding tab engages the slot.

3. The shaft assembly of claim 2, wherein
the retaining end includes a second opening, an inner circumferential surface, an outer circumferential surface, and a gap, the gap extending between the inner circumferential surface and the outer circumferential surface;
the washer inner circumferential surface includes a radially-inward protruding tab; and
in the assembled state the radially-inward protruding tab engages the gap.

4. The shaft assembly of claim 1, wherein
the lock nut includes a castellation extending from the first nut end or the second nut end, the castellation protruding within the outer shaft bore;
the coupling end includes an outer shaft surface and a lug, the lug extending radially from the outer shaft surface to an outer radial surface, the lug extending axially from the coupling end to a distal end; and
in the assembled state the coupling end lug is retained within the lock nut castellation.

5. The shaft assembly of claim 1, wherein
the retaining end includes a second opening, an inner circumferential surface, an outer circumferential surface, and a gap, the gap extending between the inner circumferential surface and the outer circumferential surface;
the washer inner circumferential surface includes a radially-inward protruding tab; and
in the assembled state the radially-inward protruding tab engages the gap.

6. The shaft assembly of claim 1, wherein
the coupling end includes an opening forming a central chamber extending axially towards the retaining end; and
in the assembled state the inner shaft second axial end is disposed within the central chamber.

7. The shaft assembly of claim 1, wherein
the lock nut includes a plurality of castellations circumferentially disposed around the lock nut and extending from the first nut end or the second nut end, the plurality of castellation extending within the outer shaft bore;
the coupling end includes an outer shaft surface and a plurality of lugs circumferentially disposed around the coupling end, each of the plurality of lugs extending radially from the outer shaft surface to an outer radial surface, each of the plurality of lugs extending axially from the coupling end to a distal end, and each of the plurality of lugs angularly offset from another by a predetermined angle; and
in the assembled state a first of the plurality of lugs engage a first of the plurality of castellations, and a second of the plurality of lugs engages a second of the plurality of castellations.

8. The shaft assembly of claim 1, further comprising
a retaining ring disposed within the outer shaft bore aft of the washer, the retaining ring including a ring outer circumferential surface which engages a groove disposed in an inner bore surface of the outer shaft.

9. The shaft assembly of claim 1, wherein the inner shaft comprises a low pressure turbine shaft.

10. The shaft assembly of claim 1, wherein
the locking shaft retaining end includes an outer circumferential surface extending axially forward to a tapered region, the tapered region extending axially towards the locking shaft body such that the outer circumferential surface tapers radially inward toward an outer shaft surface of the locking shaft body.

11. The shaft assembly of claim 10, wherein
the retaining end outer circumferential surface includes at least one radial seal, and the at least one radial seal engages an inner bore surface of the outer shaft in the assembled state.

12. The shaft assembly of claim 1, wherein
the inner shaft is in driving communication with a rotatable load.

13. A locking shaft for a gas turbine engine having a rotating assembly, the locking shaft comprising:
a coupling end, a retaining end, and a body extending axially between the coupling end and the retaining end;
the body extending between the coupling end and the retaining end, the body including a central chamber, an inner shaft surface and an outer shaft surface;
the coupling end including a lug extending radially from the outer shaft surface to an outer radial surface, the lug extending axially from the coupling end to a distal end; and
the retaining end includes a cavity, an inner circumferential surface, an outer circumferential surface, and a gap, the gap extending between the inner circumferential surface and the outer circumferential surface.

14. The locking shaft of claim 13, wherein
the coupling end includes a plurality of lugs circumferentially disposed around the coupling end, each of the plurality of lugs angularly offset from another by a predetermined angle.

15. The locking shaft of claim 13, wherein the retaining end includes a plurality of gaps circumferentially disposed around the retaining end.

16. The locking shaft of claim 13, wherein the locking shaft retaining end outer circumferential surface extends axially forward to a tapered region, and the tapered region extends axially towards the body such that the outer circumferential surface tapers radially inward toward the outer shaft surface of the body.

17. The locking shaft of claim 13, wherein the coupling end includes an opening in communication with the central chamber, the central chamber extending axially from the opening towards the retaining end.

18. The locking shaft of claim 13, wherein the coupling end includes a first diameter and the retaining end includes a second diameter, and the first diameter is less than the second diameter.

19. A method of assembling a gas turbine engine component, comprising:
providing a shaft assembly including an outer shaft, an inner shaft, and a lock nut, the outer shaft extending axially along a centerline from a forward end to an aft end, the inner shaft extending along the centerline, and a portion of the inner shaft disposed within a bore of the outer shaft;
securing the lock nut to a threaded section of the inner shaft;
inserting a locking shaft within the bore and engaging a first end of the locking shaft with an end of the lock nut;
orienting a washer to align a radially-inward protruding tab with a second end of the locking shaft, and align a radially-outward protruding tab with the outer shaft aft end; and
inserting the washer within the shaft assembly to engage the radially-inward protruding tab with the second end of the locking shaft and the radially-outward protruding tab with the aft end of the outer shaft.

20. The method of claim 19, wherein the method further comprises selecting a classification of the washer.
